(19) United States
(12) Patent Application Publication
(10) Pub. No.: US 2014/0224522 A1
(43) Pub. Date: Aug. 14, 2014

(54) INSULATED ELECTRIC WIRE AND METHOD OF MANUFACTURING THE SAME

(71) Applicant: HITACHI METALS, LTD., Tokyo (JP)

(72) Inventors: Takanori YAMAZAKI, Tokyo (JP); Toshiharu GOTO, Tokyo (JP); Hideto MOMOSE, Tokyo (JP); Shigehiro MORISHITA, Tokyo (JP)

(73) Assignee: HITACHI METALS, LTD., Tokyo (JP)

(21) Appl. No.: 14/179,077

(22) Filed: Feb. 12, 2014

(30) Foreign Application Priority Data
Feb. 13, 2013 (JP) 2013-025930

(51) Int. Cl. H01B 3/30

(52) U.S. Cl. CPC H01B 3/308
USPC 174/110 SR

(57) ABSTRACT

There is provided an insulated wire, including: a copper conductor containing copper and having an oxide layer on its surface, with a thickness of 5 nm or more and 300 nm or less; and an insulation coating formed on a surface of the oxide layer and made of a resin composition including engineering plastic having a melting point or a softening point of 220° C. or more.

### BACKGROUND

1. Technical Field

The present application is based on Japanese Applications No. 2013-025930 filed on Feb. 13, 2013, the entire contents of which are hereby incorporated by reference.

The present invention relates to an insulated wire and a method of manufacturing the same.

2. Description of Related Art

Electric equipment such as a rotary electric machine and a transformer are equipped with a coil. The coil is formed using an insulated wire, and is formed by winding the insulated wire around the core. Generally, the insulated wire is configured so that a single layer or multiple layers of insulation coating is provided on an outer periphery of a conductor having a sectional shape (for example approximately a circular shape or approximately a rectangular shape) corresponding to the purpose of use and shape of the coil. The insulated wire is formed by a method of coating and baking a surface of the conductor with an insulation coating material which is obtained by dissolving resin into an organic solvent, and a method of extruding a previously prepared resin composition on the surface of the conductor so that the conductor is coated with the extruded resin composition.

In recent years, miniaturization of the electric equipment is requested, and miniaturization is also required for the coil used for them. Owing to such a miniaturization of the coil, a space factor of the insulated wire is improved by winding the insulated wire around a core of a small diameter, with high tension and high density. For example, when the conductor having approximately a rectangular sectional surface (called a square conductor hereafter) is used, the space factor of the insulated wire is improved by winding the insulated wire in a state of being elongated and bent edgewise. Thus, when the coil is miniaturized, severe processing stress is added on the insulated wire, and therefore high mechanical characteristic is requested for the insulated wire to withstand the severe processing stress.

Further, high efficiency and high output are requested for the electric equipment, and inverter control or high voltage has been developed. Thus, a temperature for operating the coil is likely to be more increased than before, and therefore high heat-resistance is requested for the insulated wire. In addition, further high voltage such as inverter surge voltage, etc., is added on the coil, thus highly possibly causing a partial discharge to occur. Therefore high partial discharge starting voltage and excellent insulation characteristic are requested for the insulated wire.

Insulation coating which is made of engineering plastic such as polyphenylene sulfide (called PPS hereafter) is known as the insulation coating responding to the above requests. However, the insulation coating made of PPS, etc., has a low adhesion to a conductor, and therefore it is difficult to directly form the insulation coating on the conductor. This is because if the adhesion of the insulation coating is low, coating float or clacks are generated on the insulation coating when the insulated wire is processed into the coil.

Therefore, PPS, etc., is formed on the conductor via a resin layer made of other resin (for example, see patent document 1). Patent document 1 proposes an inverter surge-resistant insulated wire in which at least on layer of enamel-baking layer and at least one layer of insulation coating made of PPS, etc., are sequentially formed. According to patent document 1, high partial discharge starting voltage (about 900 Vp) and heat-resistance can be obtained by the insulated wire, without lowering an adhesion strength between the conductor and the insulation coating by interposing the enamel-baking layer between the conductor and the insulation coating. Further, the adhesion strength can be further improved by further interposing an adhesive layer between the enamel-baking layer and the insulation coating.

However, in patent document 1, since there is a large difference in a formation method between the enamel-baking layer and the insulation coating, there is a problem that a manufacturing step is easily complicated, and a manufacturing cost is increased. There is also a problem that when interposing the adhesive layer, the manufacturing cost is further increased.

In this point, there is provided a method of improving the adhesion between the insulation coating and the conductor even in a case that the insulation coating is directly formed on the conductor without interposing the enamel-baking layer or the adhesive layer (for example, see patent document 2). According to patent document 2, the adhesion between the insulation coating and the conductor is improved in such a way that the insulated wire is formed by directly forming the insulation coating on the conductor, and thereafter the insulated wire is heated again so that the insulation coating is re-melted to secure a contact between resin and the conductor, and in this state, the resin is cured.

### Patent Document 1:

Patent publication No. 4177295

### Patent Document 2:

Japanese Patent Laid Open Publication No. 2012-84256

### SUMMARY OF THE INVENTION

However, the insulated wire of patent document 2 involves a problem that a thickness of the formed insulated coating is ununiform and the insulation characteristic is low, although the adhesion between the insulation coating and the conductor is high. If the insulated wire is heated to make the insulation coating re-melted, melted resin flows from the surface of the conductor and the resin is cured in a flowing state, to thereby make the thickness of the insulation coating ununiform in some cases. Particularly, in a case of the insulated wire including a square conductor, resin flows at a corner section of the square conductor resulting in a small thickness of the insulation coating, and meanwhile the resin flows into a planar section from the corner section resulting in a large thickness of the insulation coating, thus making the thickness of the insulation coating ununiform. If the thickness of the insulation coating is ununiform, the partial discharge starting voltage of the insulated wire becomes low, and a high insulation characteristic is hardly obtained. Meanwhile, if the insulated wire is not heated, the coating float or cracks, etc., are generated on the insulation coating when being processed into the coil, due to low adhesion between the insulation coating and the conductor, although reduction of the insulation characteristic can be suppressed.

Thus, when the insulation coating is formed using PPS, etc., it is difficult to obtain both high insulation characteristic and excellent adhesion between the insulation coating and the conductor.

In view of the above-described problem, the present invention is provided, and an object of the present invention is to provide the insulated wire having high adhesion between the insulation coating and the conductor, and having excellent insulation characteristic.

According to an aspect of the present invention, there is provided an insulated wire including:

a copper conductor containing copper and having an oxide layer with a thickness of 5 nm or more and 300 nm or less; and

an insulation coating formed on a surface of the oxide layer and made of a resin composition including engineering plastic having a melting point or a softening point of 220° C. or more.

According to other aspect of the present invention, there is provided a method of manufacturing an insulated wire including:

forming an oxide layer with a thickness of 5 nm or more and 300 nm or less on a surface of a copper conductor by heating the copper conductor containing copper; and

forming an insulation coating on a surface of the oxide layer by extruding a resin composition including engineering plastic having a melting point or a softening point of 220° C. or more, on the surface of the oxide layer so that the surface is coated with the extruded resin composition.

### BRIEF DESCRIPTION OF THE DRAWINGS

FIG. 1 is a view showing a cross-sectional face of an insulated wire according to an embodiment of the present invention.

### DETAILED DESCRIPTION OF THE INVENTION

### <Knowledge Obtained by Inventors of the Present Invention>

Prior to the description of an embodiment of the present invention, knowledge obtained by inventors of the present invention will be described.

As described above, when an insulation coating made of PPS, etc., is directly formed on the conductor, adhesion between the insulation coating and the conductor is low. In this point, the adhesion between the insulation coating and the conductor can be improved by heating the insulated wire and re-melting the insulation coating.

However, resin flows by re-melting of the insulation coating, thereby making the thickness of the insulation coating ununiform, and an insulation characteristic of the insulated wire is reduced in some cases. Namely, when the insulation coating made of PPS, etc., is directly formed on the conductor, it is difficult to obtain both adhesion between the insulation coating and the conductor, and the insulation characteristic. In addition, if the thickness of the insulation coating is ununiform, a space factor of the insulated wire is decreased when the insulated wire is processed into the coil, and it is difficult to miniaturize the coil. Further, if the insulation coating is re-melted, its surface becomes smooth, and therefore when the insulation coating is coated with varnish, the adhesion of the varnish is reduced in some cases.

In order to solve the above-described problem, after strenuous efforts by the inventors of the present invention, it is found that the adhesion of the insulation coating is improved by forming the insulation coating on the conductor via the oxide layer. Conventionally, it is considered that the oxide layer is obtained by bonding of the conductor and oxygen by oxidation, which is generally fragile and is easily separated from the conductor, thus damaging the adhesion of the insulation coating. However, according to an examination by the inventors of the present invention, it is found that the oxide layer with a specific thickness is hardly separated from the conductor, and the adhesion to the insulation coating is higher than a pure conductor. It is considered that adhesion to the oxide layer is higher than the adhesion to the conductor by a contact with resin (insulation coating) via oxygen, and the adhesion of the insulation coating can be improved by forming the insulation coating on the conductor via the oxide layer. The present invention is provided based on the abovementioned knowledge.

### An Embodiment of the Present Invention

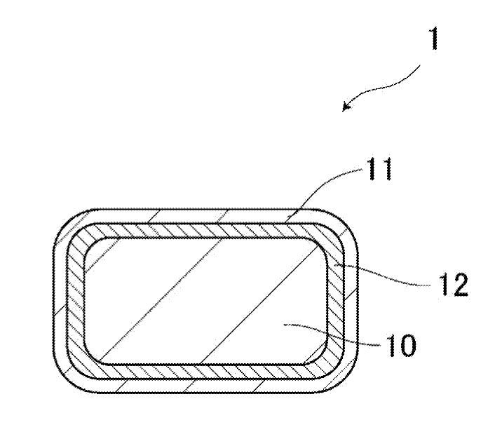

The insulated wire according to an embodiment of the present invention will be described using a figure. FIG. 1 is a view showing a cross-sectional face of an insulated wire according to an embodiment of the present invention.

### (1) Insulated Wire

An insulated wire 1 according to this embodiment includes a copper conductor 10 containing copper, and an insulation coating 11 formed on an outer periphery of the copper conductor 10, and made of a resin composition including engineering plastic having a melting point or a softening point of 220° C. or more, the copper conductor 10 further including an oxide layer 12 with a thickness of 5 nm or more and 300 nm or less on its surface.

The copper conductor 10 is not particularly limited, if copper is contained as a main component, and for example, copper wire made of low oxygen copper and non-oxygen copper, etc., or copper alloy wire containing metal other than copper, is used as the copper conductor 10. Further, a sectional shape of the copper conductor 10 is not limited to approximately a rectangular shape shown in FIG. 1, and can be formed into approximately a circular shape for example. Further, a diameter of the conductor of the copper conductor 10 is not particularly limited, and an optimal value is suitably selected according to a purpose of use.

The oxide layer 12 is formed by oxidizing the surface of the copper conductor 10, and contains copper oxide. For example, copper oxide (I) (Cu₂O) or copper oxide (II) (CuO) can be given as the copper oxide. The oxide layer 12 is combined with oxygen, and high adhesion is exhibited by contact with resin via oxygen. However, the oxide layer 12 is easily separated from the copper conductor 10 in a case of a large thickness, and therefore the thickness of the oxide layer 12 is set to 5 nm or more and 300 nm or less. If the thickness of the oxide layer is less than 5 nm, it is difficult to obtain sufficient adhesion to the insulation coating 11. Meanwhile, if the thickness exceeds 300 nm, there is a risk of separating the oxide layer 12 from the copper conductor 10, resulting in damaging the adhesion between the insulation coating 11 and the copper conductor 10.

The oxide layer 12 contains copper oxide and its content is preferably 90% or more. If the content of the copper oxide is less than 90%, there is a risk of reducing the adhesion between the insulation coating 11 and the oxide layer 12. In a case of a low adhesion between the insulation coating 11 and the oxide layer 12, there is a risk of causing a coating float or cracks to occur on the insulation coating 11 when the insulated wire 1 is bent edgewise and is processed into a coil. When the copper conductor 10 is made of pure copper, copper oxide is mainly contained in the oxide layer 12. When the copper conductor 10 is made of a copper alloy containing a metal other than copper (for example, tin, etc.), metal oxide other than copper oxide (for example, tin oxide, etc.) is contained in the oxide layer 12.

The insulation coating 11 is formed on the surface of the oxide layer 12 (on an outer periphery of the copper conductor 10). Specifically, the insulation coating 11 is formed by excluding the resin composition which is melted by heating, on the surface of the oxide layer 12. The resin composition constituting the insulation coating 11 includes engineering plastic (also called ENPLA hereafter) having a melting point or a softening point of 220° C. or more. Since the ENPLA has a high melting or softening point, the insulation coating 11 can obtain a heat resistance capable of withstand a heat generation in a case of using for the coil of a motor of an automobile, namely, the heat resistance as a wire used for winding of the coil. Further, ENPLA has a low dielectric constant, and therefore the insulation coating 11 has a high partial discharge starting voltage, and an excellent insulation characteristic. Moreover, the insulation coating 11 can obtain a high mechanical characteristic by ENPLA.

As the engineering plastic, for example, polyphenylenesulfide, polyetheretherketone, polyether ketone, thermoplastic polyimide, polyphenylene sulfone, polyether sulfone, nylon 6I (copolycondensation polymer of hexamethylenediamine and terephthalic acid), nylon 9T (copolycondensation polymer of nonanediamine and terephthalic acid), and nylon M5T (copolycondensation polymer of methylpentadiamine and terephthalic acid), as aromatic polyamide, can be given, and they may be used alone or as a blend.

Further, in order to improve various characteristics (such as flexibility or surface lubricating property), resin other than the engineering plastic may be contained in the resin composition constituting the insulation coating 11. Other resin is not particularly limited, but for example, ethylene copolymer such as polyethylene, ethylene-vinyl acetate copolymer, ethylene-ethylacrylate copolymer, ethylene-methylacrylate copolymer, and ethylene glycidyl methacrylate copolymer, and elastomer such as maleic anhydride-modified polymer may be contained, for the purpose of giving flexibility. Further, for example, fluororesin such as perfluoroalkoxy fluororesin (PFA) and hexafluoropropylene copolymer, etc., may be contained for the purpose of giving surface lubricating property.

Further, an antioxidant or a copper inhibiter, a lubricant, and a colorant, etc., may be contained in the resin composition as needed.

The thickness of the insulation coating 11 is not particularly limited, and an optimal value is selected according to a purpose of use. In this embodiment, the insulation coating 11 is made of resin such as PPS having low dielectric constant, and therefore even if the thickness is small, high partial discharge starting voltage is exhibited. Therefore, the thickness of the insulation coating can be set to 50 μm or more and 200 μm or less for example.

Further, a lubricating layer (not shown) is formed on an outer periphery of the insulation coating 11 for giving lubricating property.

### (2) Method of Manufacturing an Insulated Wire

A method of manufacturing an insulated wire will be described next.

A manufacturing method of this embodiment is the method of manufacturing an insulated wire 1, including:

forming an oxide layer 12 with a thickness of 5 nm or more and 300 nm or less on a surface of a copper conductor 10 by heating the copper conductor 10 containing copper; and

forming an insulation coating 11 on a surface of the oxide layer 12 by extruding a resin composition including engineering plastic having a melting point or a softening point of 220° C. or more, on the surface of the oxide layer 12 so that the surface is coated with the extruded resin composition.

### (Step of Forming the Oxide Layer)

First, the copper conductor 10 is fed out at a specific speed, and the copper conductor 10 is heated by a heating device. By heating, the surface of the copper conductor 10 is oxidized, to thereby form the oxide layer 12 with a thickness of 5 nm or more and 300 nm or less. A heating condition is not particularly limited to the conditions such as a heating temperature and a heating time, provided that it is the condition so that the thickness of the oxide layer 12 is a specific value. In a case of an excessively low heating temperature, oxidation efficiency of the copper conductor 10 is low, thus involving a problem that productivity is reduced. Therefore, high heating temperature is preferable, and for example, the heating temperature is preferably 220° C. or more which is close to the melting point or the softening point of ENPLA contained in the resin composition which is extruded on the oxide layer 12. Further, the heating time is not particularly limited, provided that it is the time so that the thickness of the oxide layer is 5 nm or more and 300 nm or less which is determined in consideration of a specific heating temperature, and for example the heating time can be set to less than 1 second, or about 1 second or more. Thus, formation of the oxide layer 12 is accelerated, and the productivity of the insulated wire 1 can be improved.

As a method of heating the copper conductor 10, electric conduction heating, hot air heating, induction heating, etc., can be given, and the electric conduction heating is preferable. In a case of the hot air heating, surface heat dissipation resistance (W/mm²·° C.) of the copper conductor 10 is relatively small, and the heating efficiency is low. Therefore, when a pulling speed is increased when forming the insulation coating 11 described later, a heating distance is increased. As a result, for example when the hot air heating is performed in a nitrogen atmosphere, nitrogen purge is required for the whole atmosphere of a furnace, thus deteriorating the productivity in some cases. In a case of the induction heating, high energy loss of around 90% occurs, and a low heating efficiency of around 10% occurs. Further, the heating efficiency is varied due to a positional deviation of the copper conductor 10, and therefore variation is generated in the temperature of the copper conductor 10, and the copper conductor 10 cannot be heated to a specific temperature in some cases. Meanwhile, in a case of the electric conduction heating, a high heating efficiency of 50% or more is achieved, and the copper conductor 10 can be heated in a short time. Further, the variation of the temperature of the copper conductor 10 can be suppressed.

The copper conductor 10 having the oxide layer 12 on its surface may be cooled after forming the oxide layer 12. However, as will be described later, formation of the insulation coating 11 is preferably performed in a heating state of the copper conductor 10.

### (Step of Forming the Insulation Coating)

Next, the copper conductor 10 having the oxide layer 12 on its surface, is introduced into an extruder, and the resin composition melted by heating is extruded on the surface of the copper conductor 10 having the oxide layer 12 on its surface, namely on the surface of the oxide layer 12 so that the surface of the copper conductor 10 is coated with the extruded resin composition. In such an extrusion coating, the copper conductor 10 having the oxide layer 12 on its surface, is preferably in the heating state by applying heat treatment to the copper conductor 10 in forming the oxide layer 12. The heating state of the copper conductor 10 means the state in which the temperature of the copper conductor 10 is maintained to a specific temperature (for example, the temperature of 220° C. or more which is the melting point or the softening point of ENPLA), even after end of the heat treatment in forming the oxide layer 12.

When the temperature of the oxide layer 12 in contact with the resin composition is low, a temperature difference between the oxide layer 12 and the resin composition is large, and therefore the resin composition starts to be cured instantly it is extruded on the oxide layer 12, thus involving a problem that the insulation coating 11 is formed in a state of not sufficiently adhered to the oxide layer 12. In this point, when the oxide layer 12 is in a heating state at a high temperature, the temperature difference between the oxide layer 12 and the extruded resin composition becomes small, and therefore the insulation coating 11 can be formed by curing the resin composition while securing the adhesion between the resin composition and the oxide layer 12. Namely, the adhesion between the insulation coating 11 and the oxide layer 12 can be improved.

The temperature of the copper conductor 10 having the oxide layer 12 on its surface, is not particularly limited. However, the temperature is preferably set to 220° C. or more which is the melting point or the softening point of ENPLA contained in the extruded resin composition. When the temperature of the copper conductor 10 is set to such a temperature, the copper conductor 10 may be heated at 220° C. or more in the step of forming the oxide layer.

Next, the copper conductor 10 coated with the resin composition is introduced into a cooling machine. The resin composition melted by heating is cooled by the cooling machine, which is then cured, to thereby form the insulation coating 11 and obtain the insulated wire 1. According to this insulated wire 1, the insulation coating 11 is adhered to the copper conductor 10 via the oxide layer 12. A method of cooling the resin composition is not particularly limited, and can be suitable selected from water cooling or air cooling.

### Effect of this Embodiment

According to this embodiment, one or a plurality of effects shown below can be exhibited.

According to the insulated wire 1 of this embodiment, the copper conductor 10 has the oxide layer 12 having the thickness of 5 nm or more and 300 nm or less on the surface, and the insulation coating 11 is formed on the copper conductor 10 via the oxide layer 12. Namely, the insulation coating 11 has a high adhesion to the oxide layer 12, and the oxide layer 12 having a specific thickness is hardly separated from the copper conductor 10. Thus, the insulation coating 11 has a high adhesion to the copper conductor 10. As a result, even if the insulated wire 1 is bent edgewise, and is processed into a coil, generation of the coating float or cracks can be suppressed, even when the insulated wire is bent in a single diameter.

Further, according to the insulated wire 1 of this embodiment, the insulation coating 11 is made of the resin composition including engineering plastic having the melting point or the softening point of 220° C. or more. Thus, the insulated wire 1 has excellent heat-resistance and mechanical characteristic, capable of exhibiting high partial discharge starting voltage, and has excellent insulation characteristic.

Further, according to the insulated wire 1 of this embodiment, the insulation coating 11 is not formed in a re-melted state by heating, and therefore ununiformity of the thickness of the insulation coating 11 is suppressed. Thus, reduction of the insulation characteristic due to the ununiformity of the thickness of the insulation coating 11 can be suppressed. Further, since the thickness of the insulation coating 11 is relatively uniform, and therefore the space factor for processing the insulated wire 1 into the coil can be improved. Further, since the insulation coating 11 is not re-melted by heating, the surface of the insulation coating 11 is not smooth, and therefore adhesion using the varnish, etc., used for coating the surface of the insulation coating 11, can be secured.

Further, according to the insulated wire 1 of this embodiment, copper oxide of 90% or more is preferably contained in the oxide layer 12. Thus, adhesion to the insulation coating 11 can be further improved.

Further, according to the insulated wire 1 of this embodiment, the oxide layer 12 is formed on the surface of the copper conductor 10 by heating the copper conductor 10 before the insulation coating 11 is formed on the copper conductor 10. Thus, the insulation coating 11 can be formed on the copper conductor 10 without interposing an enamel-baking layer which is conventionally required.

Further, according to the insulated wire 1 of this embodiment, the temperature for heating the oxide layer 12 is preferably set to be higher than the melting point or the softening point of the resin composition constituting the insulation coating 11. Namely, the heating temperature is preferably set to 220° C. or more which is the melting point or the softening point of the engineering plastic contained in the resin composition. Thus, formation of the oxide layer 12 is accelerated, and the productivity of the insulated wire 1 can be improved.

### EXAMPLE

Examples of the present invention will be described next. In these examples, the insulated wire was manufactured, and was evaluated by insulation characteristics and adhesion between the insulation coating and the conductor in the insulated wire. These examples are an example of the insulated wire of the present invention, and the present invention is not limited to these examples.

### (1) Material

Materials used in the following examples and comparative examples are as follows.

The following materials were used as the engineering plastic.

polyphenylene sulfide (PPS): “TORELINA” by Toray Industries, Inc. (melting point: 278° C., density 1.320 g/cm³)
Polyether etherketon (PEEK): “KetaSpire” by Solvay Specialty Polymers Japan K.K. (melting point: 340° C. density 1.30 g/cm³)
Modified polyether etherketon (modified PEEK): “AvaSpire” by Solvay Specialty Polymers Japan K.K. (melting point: 340° C. density 1.29 g/cm³)

The following material was used as the copper conductor containing copper.

Copper wire: Square conductor (sectional shape: about 2 mm×3 mm)

### (2) Manufacture of the Insulated Wire

The oxide layer having a specific thickness was formed on the surface of the copper wire by feeding out the copper wire at a specific speed, and heating the copper wire by the heating device. Subsequently, the resin composition (engineering plastic) was extruded on the surface of the oxide layer of the copper wire so that the surface was coated with the extruded resin composition. Then, the resin composition was cooled, to thereby manufacture the insulated wire. Note that the extrusion coating of the resin composition was performed so that the thickness of the insulation coating was 0.15 mm or more and 0.2 mm or less. Manufacturing conditions of the insulated wire are shown in the following table 1.

TABLE 1

| | | Example | | | | | Comparative example | | |
|---|---|---|---|---|---|---|---|---|---|
| | | 1 | 2 | 3 | 4 | 5 | 1 | 2 | 3 |
| | | PPS | | PEEK | | Modified PEEK | PPS | | Modified PEEK |
| | | (melting point: | | (melting point: | | (melting point: | (melting point: | | (melting point: |
| Resin composition | | 278° C.) | | 340° C.) | | 340° C.) | 278° C.) | | 340° C.) |
| Heating | Heating | 250 | 300 | 280 | 320 | 280 | 250 | 250 | 280 |
| condition | temperature [° C.] | | | | | | | | |
| Oxide | Thickness [nm] | 5 | 150 | 150 | 250 | 150 | 3 | 320 | 320 |
| layer | Content of oxide | ≧90 | ≧90 | ≧90 | ≧90 | ≧90 | <90 | ≧90 | ≧90 |
| | copper [%] | | | | | | | | |
| | Adhesion | ∘ | ∘ | ∘ | ∘ | ∘ | x | x | x |
| Evaluation | Partial discharge | 1600 | 1650 | 1700 | 1750 | 1780 | 1430 | 1390 | 1480 |
| | starting voltage | | | | | | | | |
| | [Vp] | | | | | | | | |

### Examples 1, 2

In examples 1 and 2, PPS was used as the resin composition. Further, the heating temperature of the copper wire was changed to 250° C. in example 1, and 300° C. in example 2.

### Examples 3, 4

In examples 3 and 4, PEEK was used as the resin composition. Further, the heating temperature of the copper wire was changed to 280° C. in example 3, and 320° C. in example 4.

### Example 5

In example 5, modified PEED was used as the resin composition. Further, the heating temperature of the copper wire was set to 280° C.

### Comparative Examples 1 to 3

In comparative examples 1 to 3, the feeding-out speed of the copper wire was suitably changed and the heating time for heating the copper wire was adjusted, to thereby change the thickness of the oxide layer. In comparative example 1, the feeding out speed was set to be higher than that of example 1 so that the oxide layer was formed thin. In comparative example 2, the feeding out speed was set to be lower than that of example 1 so that the oxide layer was formed thick. In comparative example 3, the feeding out speed was set to be low similarly to comparative example 2 so that the oxide layer was formed thicker than that of example 5.

### (3) Evaluation of the Insulated Wire

Subsequently, insulated wires of examples 1 to 5, and comparative examples 1 to 3 were evaluated by a method shown below.

### (Thickness of the Oxide Layer, Ratio of the Copper Oxide)

Regarding the manufactured insulated wire, the thickness of the oxide layer, and the ratio of the copper oxide in the oxide layer were measured. The measurement was performed by X-ray Photoelectron Spectroscopy (XPS).

### (Adhesion of the Insulation Coating)

Evaluation of the adhesion of the insulation coating was performed using a sample collected from the obtained insulated wire. Specifically, both ends of the collected sample were fixed to a tensile tester, to thereby elongate the sample until a length of 130% of an initial length was obtained, and thereafter was bent edgewise in a self-diameter. At this time, the sample without cracks and coating float on the insulation coating was regarded as success “o” and the sample with cracks and coating float generated on the insulation coating was regarded as failure “x”.

### (Insulation Characteristic)

The insulation characteristic of the insulated wire was evaluated by the partial discharge starting voltage. The partial discharge starting voltage was measured by the following procedure. Two samples (having a length of 500 mm) were cut out from the obtained insulated wire, and these two samples were twisted while applying a tension of 39N (4 kgf) thereto, to thereby prepare a sample of twisted pair having six twisted portions in a range of 120 mm in a central part. The insulation coating at an end portion (10 mm) of the sample was separated using ABISO FIX device. This sample was retained in a thermostat bath of 120° C. for 30 minutes, and was left for 18 hours until the temperature was a room temperature in a dessicator, to thereby dry the insulation coating. Thereafter, the partial discharge starting voltage of the dried sample was measured by a partial discharge automatic test system (DAC-6024) produced by SOKEN ELECTRIC CO., LTD. The measurement was performed as follows: electric charge was applied to the sample while boosting the voltage of 50 Hz at a ratio of 10 to 30 V/s, and the voltage at a point where discharge of 50 pc was generated 50 times in the sample, was selected as the partial discharged starting voltage (Vp).

### (4) Evaluation Result

As shown in table 1, in examples 1 to 5, high adhesion between the insulation coating and the copper wire was confirmed. It was also confirmed that the partial discharge starting voltage was 1600 Vp or more and high insulation characteristic was exhibited.

Meanwhile, in comparative example 1, the thickness of the oxide layer was small, and the copper oxide contained in the oxide layer was less than 90%, and therefore a low adhesion of the insulation coating was confirmed. In addition, due to such a low adhesion of the insulation coating, the insulation coating was floated, and therefore low insulation characteristic was confirmed. In comparative example 2 and 3, the thickness of the oxide layer was large, and therefore low adhesion of the insulation coating was confirmed. This is because due to excessive thickness of the oxide layer, the oxide layer was separated from the surface of the copper conductor, resulting in reduction of the adhesion. Further, due to low adhesion of the insulation coating, thus generating the coating float, the partial discharge starting voltage was a low value, and therefore low insulation characteristic was confirmed.

### <Preferable Aspect of the Present Invention>

Preferable aspects of the present invention will be described hereafter.

According to an aspect of the present invention, there is provided an insulated wire, including:

a copper conductor containing copper and having an oxide layer on its surface, with a thickness of 5 nm or more and 300 nm or less; and

an insulation coating formed on a surface of the oxide layer and made of a resin composition including engineering plastic having a melting point or a softening point of 220° C. or more.

Preferably, there is provided the insulated wire wherein the oxide layer contains copper oxide of 90% or more.

Preferably, there is provided the insulated wire, wherein the engineering plastic is at least one kind selected from a group consisting of polyphenylene sulfide, polyether etherketon, polyether keton, thermoplastic polyimide, polyphenylene sulphone, polyether sulphone, copolycondensation polymer of hexamethylenediamine and terephthalic acid, copolycondensation polymer of nonanediamine and terephthalic acid, and copolycondensation polymer of methylpentadiamine and terephthalic acid.

According to other aspect of the present invention, there is provided a method of manufacturing an insulated wire including:

forming an oxide layer with a thickness of 5 nm or more and 300 nm or less on a surface of a copper conductor by heating the copper conductor containing copper; and

forming an insulation coating on a surface of the oxide layer by extruding a resin composition including engineering plastic having a melting point or a softening point of 220° C. or more, on the surface of the oxide layer so that the surface is coated with the extruded resin composition.

Preferably, there is provided the method of manufacturing an insulated wire, wherein in forming the oxide layer, the copper conductor is heated at a temperature of a melting point or a softening point or more of the engineering plastic.

Preferably, there is provided the method of manufacturing an insulated wire, wherein in forming the insulation coating, the resin composition is extruded on the surface of the copper conductor in a heating state by applying heat treatment to the copper conductor in forming the oxide layer.

Preferably, there is provided the method of manufacturing an insulated wire, wherein in forming the oxide layer, heat treatment is applied to the copper conductor by electric conduction heating.

What is claimed is:

1. Insulated wire, comprising:
a copper conductor containing copper and having an oxide layer on its surface, with a thickness of 5 nm or more and 300 nm or less; and
an insulation coating formed on a surface of the oxide layer and made of a resin composition including engineering plastic having a melting point or a softening point of 220° C. or more.

2. The insulated wire according to claim 1, wherein the oxide layer contains copper oxide of 90% or more.

3. The insulated wire according to claim 1, wherein the engineering plastic is at least one kind selected from a group consisting of polyphenylene sulfide, polyether etherketon, polyether keton, thermoplastic polyimide, polyphenylene sulphone, polyether sulphone, copolycondensation polymer of hexamethylenediamine and terephthalic acid, copolycondensation polymer of nonanediamine and terephthalic acid, and copolycondensation polymer of methylpentadiamine and terephthalic acid.

4. A method of manufacturing an insulated wire, comprising:
forming an oxide layer with a thickness of 5 nm or more and 300 nm or less on a surface of a copper conductor by heating the copper conductor containing copper; and
forming an insulation coating on a surface of the oxide layer by extruding a resin composition including engineering plastic having a melting point or a softening point of 220° C. or more, on the surface of the oxide layer so that the surface is coated with the extruded resin composition.

5. The method of manufacturing an insulated wire according to claim 4, wherein in forming the oxide layer, the copper conductor is heated at a temperature of a melting point or a softening point or more of the engineering plastic.

6. The method of manufacturing an insulated wire according to claim 4, wherein in forming the insulation coating, the resin composition is extruded on the surface of the copper conductor in a heating state by applying heat treatment to the copper conductor in forming the oxide layer.

7. The method of manufacturing an insulated wire, wherein in forming the oxide layer, heat treatment is applied to the copper conductor by electric conduction heating.
